(19) United States
(12) Patent Application Publication
(10) Pub. No.: US 2011/0258126 A1
(43) Pub. Date: Oct. 20, 2011

(54) SYSTEMS AND METHODS FOR DETERMINING A WARRANTY OBLIGATION OF A SUPPLIER TO AN ORIGINAL EQUIPMENT MANUFACTURER FOR A VEHICLE BATTERY PACK

(75) Inventors: Prabhakar Patil, Southfield, MI (US); Michael Trader, Royal Oak, MI (US); John Longnecker, Livonia, MI (US)

(73) Assignee: LG CHEM, LTD., Seoul (KR)

(21) Appl. No.: 12/870,940

(22) Filed: Aug. 30, 2010

Related U.S. Application Data
(60) Provisional application No. 61/324,102, filed on Apr. 14, 2010.

(51) Int. Cl. G06Q 10/00

(52) U.S. Cl. 705/302

(57) ABSTRACT

A method for determining a warranty obligation of a supplier to an OEM for a vehicle battery pack of a vehicle is provided. The battery pack was previously purchased by the OEM from the supplier. The method includes retrieving an operational parameter associated with a component of the vehicle battery pack or a battery management system. The method further includes determining whether the operational parameter is less than or equal to a threshold value. The method further includes reimbursing the OEM or crediting a financial account associated with the OEM for at least a portion of the cost of the replacement battery pack by the supplier if the operational parameter is less than or equal to the threshold value.

### CROSS-REFERENCE TO RELATED APPLICATIONS

This application claims priority to U.S. Provisional Patent Application No. 61/324,102 filed on Apr. 14, 2010, the entire contents of which are hereby incorporated by reference herein.

### BACKGROUND

Electric vehicles and hybrid electric vehicles utilize vehicle battery packs to provide electrical power for an electric motor. The electrical motor is coupled to a vehicle drive train to control movement of the vehicle. Original equipment manufacturers (OEMs) that manufacture vehicles or subsystems of vehicles may purchase a vehicle battery pack from a supplier. The supplier can either manufacture a vehicle battery packs or be a distributor of vehicle battery packs. However, when a vehicle battery pack becomes degraded, it may be difficult to determine whether the supplier has a warranty obligation to the OEM.

Accordingly, the inventors herein have recognized a need for a system and a method for determining a warranty obligation of a supplier to an OEM for a vehicle battery pack.

### SUMMARY

A method for determining a warranty obligation of a supplier to an OEM relating to a vehicle battery pack of a vehicle in accordance with an exemplary embodiment is provided. The vehicle battery pack was previously purchased by the OEM from the supplier. The method includes retrieving a stored operational parameter associated with at least one component of the vehicle battery pack or a battery management system from a memory device of the battery management system, utilizing a computer. The method further includes determining whether the operational parameter is less than or equal to a threshold value, if the vehicle battery pack has degraded performance due to the component and the vehicle battery pack is replaced by the OEM with a replacement battery pack. The method further includes reimbursing the OEM or crediting a financial account associated with the OEM for at least a portion of the cost of the replacement battery pack by the supplier if the operational parameter is less than or equal to the threshold value and the vehicle battery pack has degraded performance due to the component and the vehicle battery pack is replaced by the OEM with the replacement battery pack.

A method for determining a warranty obligation of a supplier to an OEM relating to a vehicle battery pack of a vehicle in accordance with another exemplary embodiment is provided. The vehicle battery pack was previously purchased by the OEM from the supplier. The method includes retrieving a stored operational parameter associated with at least one component of the vehicle battery pack or a battery management system from a memory device of the battery management system, utilizing a computer. The method further includes determining whether the operational parameter is greater than a threshold value, if the vehicle battery pack has degraded performance due to the component and the vehicle battery pack is replaced by the OEM with a replacement battery pack. The method further includes reimbursing the OEM or crediting a financial account associated with the OEM for at least a portion of the cost of the replacement battery pack by the supplier if the operational parameter is greater than the threshold value and the vehicle battery pack has degraded performance due to the component and the vehicle battery pack is replaced by the OEM with the replacement battery pack.

A method for determining a warranty obligation of a supplier to an OEM relating to a vehicle battery pack of a vehicle in accordance with another exemplary embodiment is provided. The vehicle battery pack was previously purchased by the OEM from the supplier. The method includes retrieving a stored event code associated with an event that has occurred in the vehicle battery pack or has occurred in the vehicle from a memory device of a battery management system, utilizing a computer. The method further includes determining whether the stored event code corresponds to a predetermined event code, if the vehicle battery pack has degraded performance due to the event and the vehicle battery pack is replaced by the OEM with a replacement battery pack. The method further includes reimbursing the OEM or crediting a financial account associated with the OEM for at least a portion of the cost of the replacement battery pack by the supplier if the stored event code corresponds to the predetermined event code and the vehicle battery pack has degraded performance due to the event associated with the event code and the vehicle battery pack is replaced by the OEM with the replacement battery pack.

A method for determining a warranty obligation of a supplier to an OEM relating to a vehicle battery pack of a vehicle in accordance with another exemplary embodiment is provided. The vehicle battery pack was previously purchased by the OEM from the supplier. The method includes retrieving a stored event code associated with an event that has occurred in the vehicle battery pack or has occurred in the vehicle from a memory device of a battery management system, utilizing a computer. The method further includes determining whether the stored event code corresponds to a predetermined event code, if the vehicle battery pack has degraded performance due to the event and the vehicle battery pack is replaced by the OEM with a replacement battery pack. The method further includes not reimbursing the OEM or crediting a financial account associated with the OEM for at least a portion of the cost of the replacement battery pack by the supplier if the stored event code corresponds to the predetermined event code and the vehicle battery pack has degraded performance due to the event associated with the event code and the vehicle battery pack is replaced by the OEM with the replacement battery pack.

A method for determining a warranty obligation of a supplier to an OEM relating to a vehicle battery pack of a vehicle in accordance with another exemplary embodiment is provided. The vehicle battery pack was previously purchased by the OEM from the supplier. The method includes retrieving a stored operational parameter associated with at least one component of the vehicle battery pack or a battery management system from a memory device of the battery management system, utilizing a computer. The method further includes determining whether the operational parameter is within a predetermined operational parameter range, if the vehicle battery pack has degraded performance due to the component and the vehicle battery pack is replaced by the OEM with a replacement battery pack, the predetermined operational parameter range having an upper threshold value and a lower threshold value. The method further includes reimbursing the OEM or crediting a financial account associated with the OEM for at least a portion of the cost of the replacement battery pack by the supplier if the operational parameter is within the predetermined operational parameter range and the vehicle battery pack has degraded performance due to the component and the vehicle battery pack is replaced by the OEM with the replacement battery pack.

These and other advantages and features will become more apparent from the following description taken in conjunction with the drawings.

### BRIEF DESCRIPTION OF THE DRAWINGS

FIG. 1 is a schematic of a warranty obligation determination system in accordance with an exemplary embodiment;

FIG. 2 is a block diagram of a microprocessor and a non-volatile memory device utilized in the system of FIG. 1;

FIG. 3 is a flowchart of a method for determining a warranty obligation in accordance with another exemplary embodiment;

FIG. 4 is a flowchart of another method for determining a warranty obligation in accordance with another exemplary embodiment;

FIG. 5 is a flowchart of another method for determining a warranty obligation in accordance with another exemplary embodiment;

FIG. 6 is a flowchart of another method for determining a warranty obligation in accordance with another exemplary embodiment;

FIG. 7 is a block diagram illustrating a supplier, an OEM, a vehicle owner, and associated warranty contracts; and

FIG. 8 is a flowchart of another method for determining a warranty obligation in accordance with another exemplary embodiment.

### DETAILED DESCRIPTION

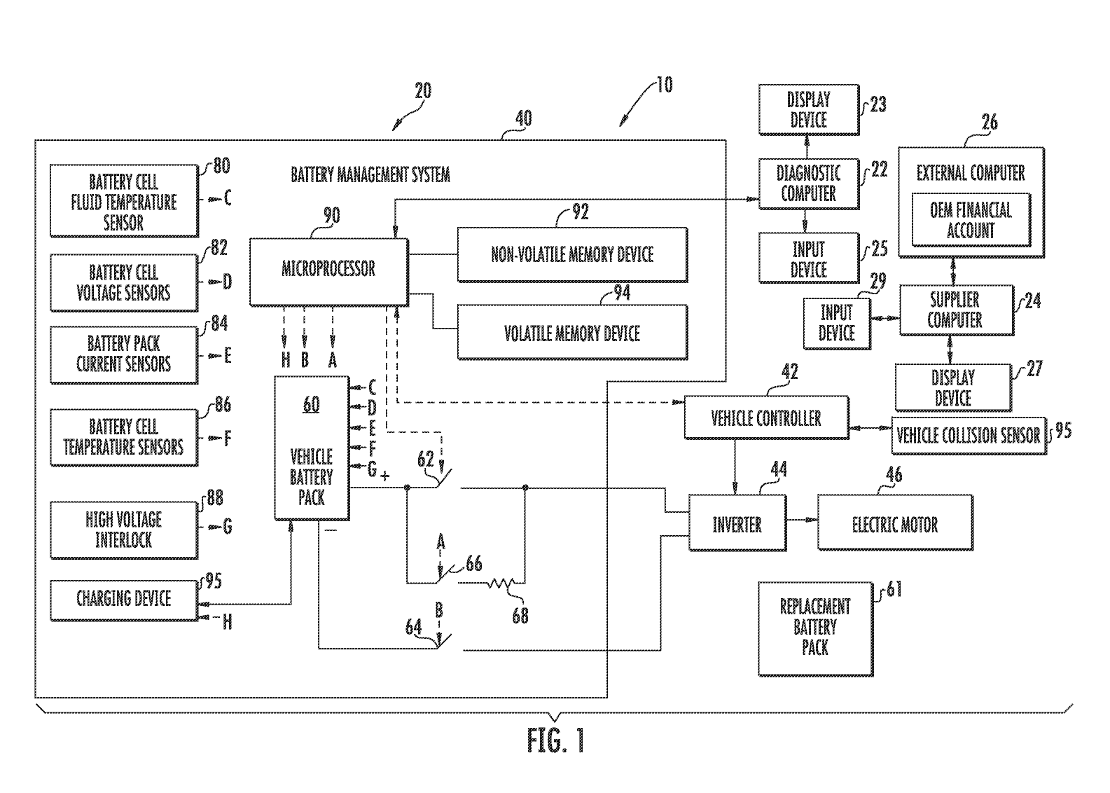

Referring now to the FIG. 1, a warranty obligation determination system 10 in accordance with an exemplary embodiment is illustrated. The system 10 includes a vehicle 20, a diagnostic computer 22, a display device 23, an input device 25, a supplier computer 24, a display device 27, an input device 29, and an external computer 26.

For purposes of understanding, the term “supplier” refers to a manufacturer or a distributor of a vehicle battery pack, and can include one or more employees thereof. The term original equipment manufacturer “OEM” refers to a purchaser of a vehicle battery pack from the supplier. In one exemplary embodiment, an OEM is an original equipment manufacturer of a vehicle, or a vehicle subsystem such as a vehicle drive train for example. The term “vehicle battery pack” refers to a battery assembly having at least one battery cell that provides power to an electric motor that is a primary or auxiliary drive mechanism for a vehicle drive train. The term “operational parameter” refers to a measured or an inferred value. The term “battery management system” refers to a system that controls a charging and a discharging of a vehicle battery pack. A battery management system may also store operational parameters and event data associated with the vehicle battery pack in a memory device. The term “technical specification” refers to a document describing the functional requirements for the battery management system, or the vehicle battery pack, or both.

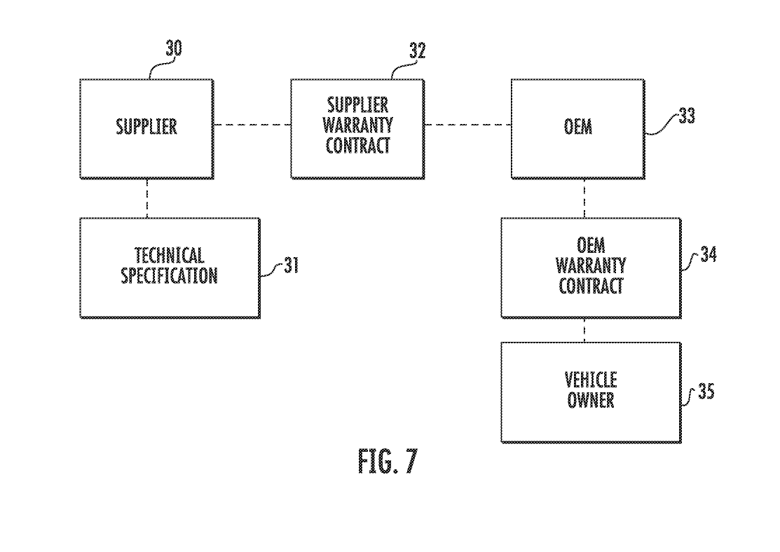

Referring to FIG. 7, before describing the warranty obligation determination system 10 is further detail, a general overview of exemplary business relationships between a supplier, an OEM, and a vehicle owner will be described. As shown, a supplier 30 has a supplier warranty contract 32 with an OEM 33. The supplier warranty contract 32 between the supplier 30 and the OEM 33 defines the warranty obligations of the supplier 30 to the OEM associated with a vehicle battery pack 60. The OEM 33 purchases the vehicle battery pack 60 from the supplier 30. The technical specification 31 describes the functional requirements for the battery management system 40, or the vehicle battery pack 60, or both. Further, the OEM 33 has an OEM warranty contract 34 with a vehicle owner 35 that purchases the vehicle 20 having the battery management system 40 and the vehicle battery pack 60 therein from the OEM 33. The OEM warranty contract 34 between the vehicle owner 35 defines warranty obligations of the OEM 33 to the vehicle owner 35 associated with the vehicle battery pack 60.

Referring again to FIG. 1, the warranty obligation determination system 10 will now be explained in further detail. The vehicle 20 is provided to transport vehicle occupants therein. The vehicle 20 includes a battery management system 40, a vehicle battery pack 60, a vehicle controller 42, an inverter 44, and an electric motor 46.

The battery management system 40 is provided to control operation of the vehicle battery pack 60. Further, the system 40 is provided to store operational parameters of the vehicle battery pack 60 and events associated with the battery pack 60 and the vehicle 20 in a non-volatile memory device 92, for subsequent determination of a warranty obligation between the supplier 30 and the OEM 33. The battery management system 40 includes contactors 62, 64, a relay 66, a pre-charge resistor 68, a battery cell fluid temperature sensor 80, battery cell voltage sensors 82, battery pack current sensors 84, battery cell temperature sensors 86, a high-voltage interlock 88, a microprocessor 90, a non-volatile memory device 92, a volatile memory device 94, and a charging device 95.

The vehicle battery pack 60 is provided to supply electrical power to the electric motor 46 via the inverter 44. The vehicle battery pack 60 includes a plurality of battery cells therein that may be electrically coupled either in series or in parallel to one another. In one exemplary embodiment, the vehicle battery pack 60 includes a plurality of pouch-type lithium-ion battery cells. Of course, in alternative embodiments, other types of battery cells known to those skilled in the art could be utilized. Further, in one exemplary embodiment, the vehicle battery pack 60 has a plurality of heat exchangers that are disposed between the battery cells that receive a fluid therein for extracting heat energy from the battery cells to maintain a temperature of the battery cells within a desired temperature range. When the vehicle battery pack 60 has degraded operation, an owner of the vehicle 20 may bring the vehicle 20 to a vehicle dealership associated with the OEM 33. Further, the vehicle dealership may replace the vehicle battery pack 60 in the vehicle 20 with a replacement battery pack 61.

The contactors 62, 64 are provided to selectively supply a voltage to the inverter 44, in response to control signals from the microprocessor 90. The contactors 62, 64 have either an open operational state or a closed operational state, based on the control signals from the microprocessor 90. Further, the contactors 62, 64 are high-voltage contactors.

The relay 66 and the resistor 68 are electrically coupled in series with one another. Further, the relay 66 and a resistor 60 are electrically coupled in parallel with the contactor 62. The microprocessor 90 can generate a control signal to induce the relay 66 to have a closed operational state, while the contactor 62 has an open operational state and the contactor 64 has a closed operational state, to allow the vehicle battery pack 62 to supply a current limited level to the inverter 44 when desired. Thereafter, the microprocessor 90 can generate another control signal to close the contactor 62 to allow the vehicle battery pack 60 supply high current levels to the inverter 44.

The battery cell fluid temperature sensor 80 is configured to generate a signal indicative of a temperature level of the fluid flowing through the heat exchangers or cooling manifolds of the vehicle battery pack 60. The sensor 80 is electrically coupled to the microprocessor 90 that receives the signal from the sensor 80.

The battery cell voltage sensors 82 are configured to generate signals indicative of voltage levels of the battery cells in the vehicle battery pack 60. The sensors 82 are electrically coupled to the microprocessor 90 that receives the signals from the sensors 82.

The battery pack current sensors 84 are configured to generate signals indicative of an amount of current flowing through the battery cells in the vehicle battery pack 60. The sensors 84 are electrically coupled to the microprocessor 90 that receives the signals from the sensors 84.

The battery cell temperature sensors 86 are configured to generate signals indicative of temperature levels of the battery cells in the vehicle battery pack 60. The sensors 86 disposed in close proximity to the battery cells and are electrically coupled to the microprocessor 90 that receives the signals from the sensors 86.

The high-voltage interlock 88 is provided to open the contactors 62, 64 before an operator works on the vehicle battery pack 60. The high-voltage interlock 88 is electrically coupled to the microprocessor 90.

The charging device 95 is provided to charge battery cells in the vehicle battery pack 60 in response to a control signal from the microprocessor 90. The charging device 95 may be disposed external of the vehicle 10 or within the vehicle 10.

The microprocessor 90 is configured to receive signals from the various sensors discussed above and from the high-voltage interlock 88. Further, microprocessor 90 is configured to control the contactors 62, 64 and the relay 66 for controlling current flow to the inverter 44. Also, microprocessor 90 is configured to store operational parameters associated with received signals in the non-volatile memory device 92, which will be utilized for determining a warranty obligation of a supplier 30 to an OEM 33 discussed in further detail below. Still further, the microprocessor 90 is configured to store event codes associated with the events relating to either the vehicle battery pack 60 or the vehicle 20 in general, in the non-volatile memory device 92, which will be utilized for determining a warranty obligation of the supplier 30 to the OEM 33 discussed in further detail below. During operation, the microprocessor 90 operably communicates with the non-volatile memory device 92, the volatile memory device 94. Further, the microprocessor 90 may communicate with the diagnostic computer 22 and the charging device 95.

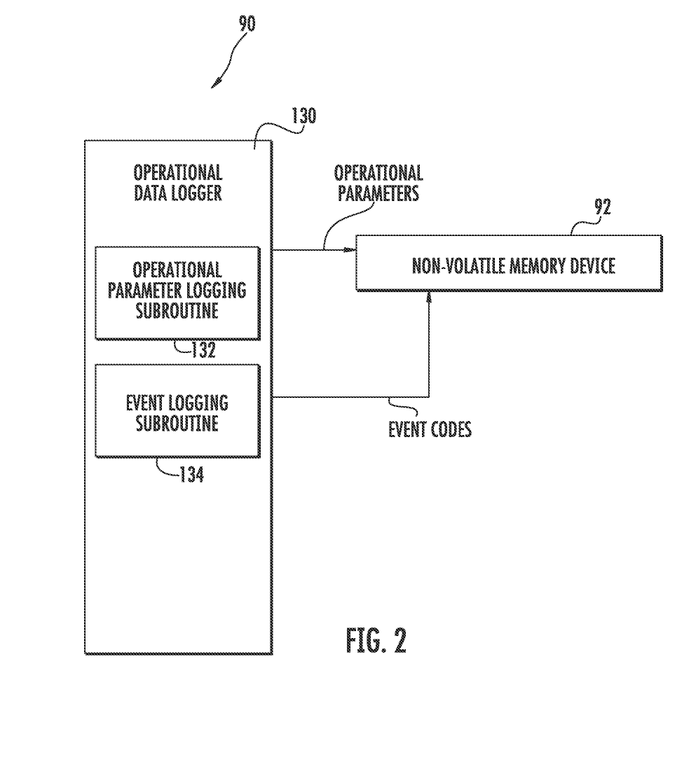

Referring to FIG. 2, the software subroutines that the microprocessor 90 executes to log or store the operational parameters and event codes associated with the vehicle battery pack 60 and the vehicle 20, will now be explained. The microprocessor 90 executes an operational data logger (ODR) program 130 to store the operational parameters and event codes in the non-volatile memory device 92. The operational data logger 130 has two subroutines: the operational parameter logging subroutine 132 and the event logging subroutine 134.

The operational parameter logging subroutine 132 stores operational parameters associated with the vehicle battery pack 60 and the vehicle 20 in the memory device 92. The subroutine 132 can store the operational parameters at predetermined time intervals. Exemplary operational parameters that are stored by the subroutine 132 include: a battery state, cell temperature levels, cell voltage levels, battery pack currents, a state of charge of the battery cells, a battery pack energy throughput, faults, main contactor states indicating closing and opening states of the contactors 62, 64, power limits of the vehicle battery pack, vehicle battery pack capacity, cell balancing data, auxiliary contactor status, charger contactor status, and thermal control data associated with a thermal control device of the vehicle battery pack 60. Of course, other operational parameters of the vehicle battery pack 60 known to those skilled in the art can be stored by the subroutine 132 in the memory device 92.

The event logging subroutine 134 stores the event codes associated with the battery pack 60 and the vehicle 20 in the memory device 92. The subroutine 134 can store the event codes in the memory device 92 in real-time when an associated event is detected by the microprocessor 90. Exemplary event codes that can be stored by the subroutine 134 are associated with the following events: a service disconnect module being removed from the battery management system 40, an isolation status, and a vehicle collision event. Of course, other event codes associated with the vehicle battery pack 60 and the vehicle 20 known to those skilled in the art can be stored by the subroutine 134 in the memory device 92.

Referring again to FIG. 1, the vehicle controller 42 operably communicates with the microprocessor 90, the inverter 44, and the vehicle collision sensor 95. During operation, the vehicle controller 42 generates a control signal to induce the inverter 42 to supply current to the electric motor 46 when movement of the vehicle 20 is desired. Further, the vehicle controller 42 can receive a signal from the vehicle collision sensor 95 indicating a vehicle collision event has occurred, and the controller 42 can send another signal to the microprocessor 90 indicating that the vehicle collision event occurred.

The diagnostic computer 22 is configured to communicate with the microprocessor 90 to retrieve stored operational parameters and event codes in the non-volatile memory device 92, utilizing the input device 25. The diagnostic computer 22 also displays the retrieved operational parameters and event codes on the display device 23 operably coupled to the diagnostic computer 22. In one exemplary embodiment, the input device 25 and the display device 23 are integrated in the diagnostic computer 22.

The supplier computer 24 is configured to communicate with an external computer 26. In one exemplary embodiment, the supplier computer 24 can credit an OEM financial account maintained by the external computer 26 for least a portion of cost of a replacement battery pack 61 if desired by the supplier 30. In one exemplary embodiment, the supplier computer 24 can communicate through a communication network (not shown) with the external computer 26.

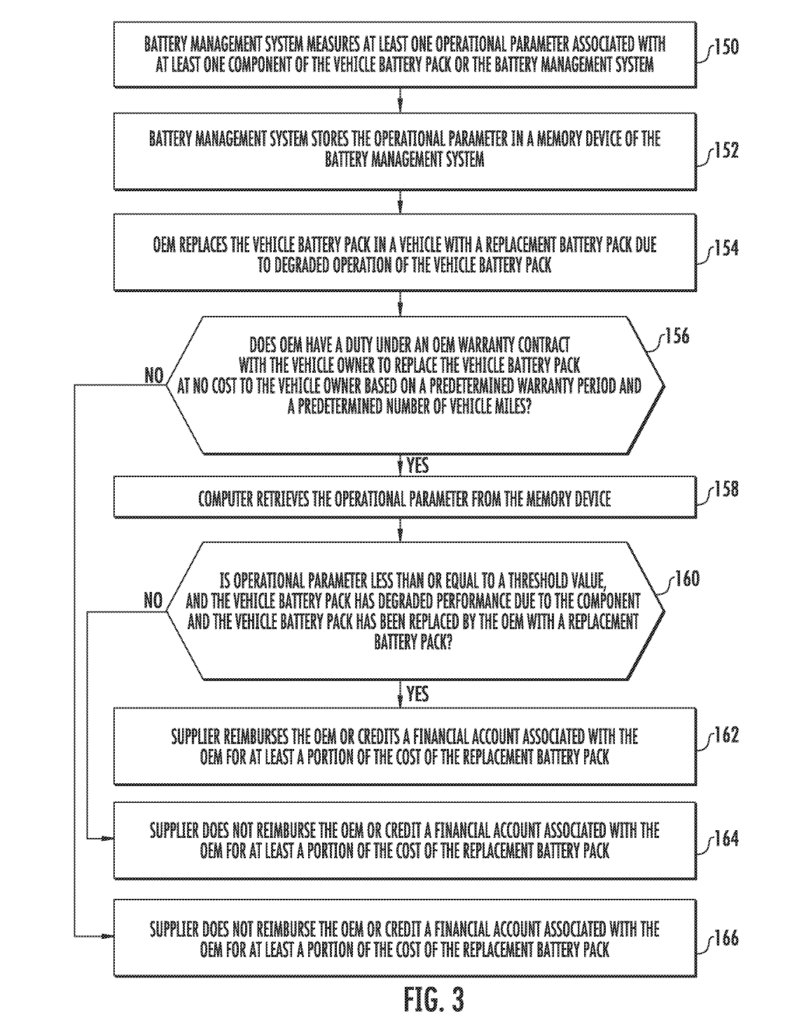

Referring to FIG. 3, a flowchart of a method for determining a warranty obligation utilizing an operational parameter in accordance with another exemplary embodiment will now be explained.

At step 150, the battery management system 40 measures at least one operational parameter associated with at least one component of the vehicle battery pack 60 or the battery management system 40.

At step 152, the battery management system 40 stores the operational parameter in the memory device 92 of the battery management system 40.

At step 154, the OEM 33 replaces the vehicle battery pack 60 in the vehicle 20 with a replacement battery pack 61 due to degraded operation of the vehicle battery pack 60.

At step 156, a determination is made as to whether the OEM 33 has a duty under an OEM warranty contract 34 with the vehicle owner 35 to replace the vehicle battery pack 60 at no cost to the vehicle owner 35 based on a predetermined warranty period and a predetermined number of vehicle miles. In one exemplary embodiment, the OEM 33 performs the step 156 and communicates the determination to the supplier 30. In another exemplary embodiment, the supplier 30 utilizes the supplier computer 24 to communicate with an external computer 26 to determine whether the OEM 33 has a warranty obligation to the vehicle owner 35. If the value of step 156 equals “yes”, the method advances to step 158. Otherwise, the method advances to step 166.

At step 158, the computer 22 retrieves the operational parameter from the memory device 92.

At step 160, a determination is made as to whether the operational parameter is less than or equal to a threshold value, and the vehicle battery pack 60 has degraded performance due to the component, and the vehicle battery pack 60 has been replaced by the OEM 33 with a replacement battery pack 61. The supplier 30 or the OEM 33, or both can make the determination at step 160. In one exemplary embodiment, the supplier computer 24 retrieves the operational parameter data from the microprocessor 90, and data from a technical specification database describing the technical specification that can be stored in the computer 24, and warranty data from the external computer 26 to make the determination at step 160. The computer 24 may further display the retrieved data, and/or the determination or results of step 160 on the display device 27. Further, in an alternative embodiment, the determination at step 160 may be manually performed by the supplier 30 or the OEM 33, or both. If the value of step 160 equals “yes”, the method advances to step 162. Otherwise, the method advances to step 164.

At step 162, the supplier 30 reimburses the OEM 33 or credits a financial account associated with the OEM 33 for at least a portion of the cost of the replacement battery pack 61.

At step 164, the supplier 30 does not reimburse the OEM 33 or credit a financial account associated with the OEM 33 for at least a portion of the cost of the replacement battery pack 61.

Referring again to step 156, the value of step 106 equals “no”, the step 166 is performed and the supplier 30 does not reimburse the OEM 33 or credit a financial account associated with the OEM 33 for at least a portion of the cost of the replacement battery pack 61.

A few practical examples of how the method described in FIG. 3 could be implemented will now be explained. In a first example, for purposes of discussion, it is assumed that the OEM 33 has a duty under an OEM warranty contract 34 with the vehicle owner 35 to replace the vehicle battery pack 60. Further, a component that is covered by the supplier warranty contract 32 between the OEM 33 and the supplier 30 is at least one of the power contactors 62, 64 of the battery management system 40 and the operational parameter is a number of open operational states of the power contactors 62, 64 at full-load over a predetermined time interval. The threshold number of open operational states of the power contactors at full load over the predetermined time interval are identified in a technical specification or other document associated with the battery management system 40. If a number of open operational states of at least one of the power contactors 62, 64 at full load is greater than the threshold number of open operational states, and the battery pack has degraded performance due to at least one of the power contactors 62, 64 which requires replacement of the vehicle battery pack 60, the supplier 30 would not have a duty to reimburse the OEM 33 for the cost of the replacement battery pack 61. However, if the number of open operational states of the power contactors 62, 64 at full load is less than or equal to the threshold number of open operational states, and the vehicle battery pack 60 has degraded performance due to at least one of the power contactors 62, 64 which requires replacement of the vehicle battery pack 60, the supplier 30 would have a duty to reimburse the OEM 33 for the cost of the replacement battery pack 61. The cost of the replacement battery pack 61 may include a purchase price of the replacement battery pack 61, labor costs associated with installing the replacement battery pack 61 in the vehicle, and shipping costs of the replacement battery pack 61.

In a second example, for purposes of discussion, it is assumed that the OEM 33 has a duty under an OEM warranty contract 34 with the vehicle owner 35 to replace the vehicle battery pack 60. Further, a component that is covered by the supplier warranty contract 32 between the OEM 33 and the supplier 30 is at least one of the power contactors 62, 64 of the battery management system 40 and the operational parameter is a number of open operational states of the power contactors 62, 64 because of fault conditions (e.g., high-voltage interlock loop “HVIL” fault) over a predetermined time interval. The threshold number of open operational states of the power contactors because of fault conditions over the predetermined time interval are identified in a technical specification or other document associated with the battery management system 40. If a number of open operational states of at least one of the power contactors 62, 64 because of fault conditions is greater than the threshold number of open operational states because of fault conditions, and the battery pack has degraded performance due to at least one of the power contactors 62, 64 which requires replacement of the vehicle battery pack 60, the supplier 30 would not have a duty to reimburse the OEM 33 for the cost of the replacement battery pack 61. However, if the number of open operational states of the power contactors 62, 64 because of fault conditions is less than or equal to the threshold number of open operational states because of fault conditions, and the vehicle battery pack 60 has degraded performance due to at least one of the power contactors 62, 64 which requires replacement of the vehicle battery pack 60, the supplier 30 would have a duty to reimburse the OEM 33 for the cost of the replacement battery pack 61, if no other operational parameters or contract provisions would obviate the duty to reimburse the OEM 33.

In a third example, for purposes of discussion, it is assumed that the OEM 33 has a duty under an OEM warranty contract 34 with the vehicle owner 35 to replace the vehicle battery pack 60. Further, a component that is covered by the supplier warranty contract 32 between the OEM 33 and the supplier 30 is at least one of the power contactors 62, 64 of the battery management system 40 and the operational parameter is a number of open operational states of the power contactors 62, 64 because of vehicle collision signals indicating a vehicle collision condition over a predetermined time interval. The threshold number of open operational states of the power contactors because of vehicle collision signals over the predetermined time interval are identified in a technical specification or other document associated with the battery management system 40. If a number of open operational states of at least one of the power contactors 62, 64 because of vehicle collision signals is greater than the threshold number of open operational states because of vehicle collision signals, and the battery pack has degraded performance due to at least one of the power contactors 62, 64 which requires replacement of the vehicle battery pack 60, the supplier 30 would not have a duty to reimburse the OEM 33 for the cost of the replacement battery pack 61. However, if the number of open operational states of the power contactors 62, 64 because of vehicle collision signals is less than or equal to the threshold number of open operational states because of vehicle collision signals, and the vehicle battery pack 60 has degraded performance due to at least one of the power contactors 62, 64 which requires replacement of the vehicle battery pack 60, the supplier 30 would have a duty to reimburse the OEM 33 for the cost of the replacement battery pack 61, if no other operational parameters or contract provisions would obviate the duty to reimburse the OEM 33.

In a fourth example, for purposes of discussion, it is assumed that the OEM 33 has a duty under an OEM warranty contract 34 with the vehicle owner 35 to replace the vehicle battery pack 60. Further, a component that is covered by the supplier warranty contract 32 between the OEM 33 and the supplier 30 is at least one of the power contactors 62, 64 of the battery management system 40 and the operational parameter is a number of closed operational states of the power contactors 62, 64 over a predetermined time interval. The threshold number of closed operational states of the power contactors over the predetermined time interval are identified in a technical specification or other document associated with the battery management system 40. If a number of closed operational states of at least one of the power contactors 62, 64 is greater than the threshold number of closed operational states, and the battery pack has degraded performance due to at least one of the power contactors 62, 64 which requires replacement of the vehicle battery pack 60, the supplier 30 would not have a duty to reimburse the OEM 33 for the cost of the replacement battery pack 61. However, if the number of closed operational states of the power contactors 62, 64 is less than or equal to the threshold number of closed operational states, and the vehicle battery pack 60 has degraded performance due to at least one of the power contactors 62, 64 which requires replacement of the vehicle battery pack 60, the supplier 30 would have a duty to reimburse the OEM 33 for the cost of the replacement battery pack 61, if no other operational parameters or contract provisions would obviate the duty to reimburse the OEM 33.

In a fifth example, for purposes of discussion, it is assumed that the OEM 33 has a duty under an OEM warranty contract 34 with the vehicle owner 35 to replace the vehicle battery pack 60. Further, a technical specification agreed upon between the OEM 33 and the supplier 30 indicates a maximum discharging current threshold level or a maximum charging current threshold level associated with the vehicle battery pack 60 above which could degrade or damage the vehicle battery pack 60. If the measured operational parameter is the discharging current level and the discharging current level is greater than the maximum discharging current threshold level and the battery pack 60 has degraded performance due to the discharging current level, the supplier 30 would not have a duty to reimburse the OEM 33 for the cost of the replacement battery pack 61. Similarly, if the measured operational parameter is the charging current level and the charging current level is greater than the maximum charging current threshold level and the battery pack 60 has degraded performance due to the charging current level, the supplier 30 would not have a duty to reimburse the OEM 33 for the cost of the replacement battery pack 61.

In a sixth example, for purposes of discussion, it is assumed that the OEM 33 has a duty under an OEM warranty contract 34 with the vehicle owner 35 to replace the vehicle battery pack 60. Further, a technical specification agreed upon between the OEM 33 and the supplier 30 indicates a maximum temperature level associated with the battery cells of the vehicle battery pack 60 above which could degrade or damage the vehicle battery pack 60. If the measured operational parameter is the temperature level of the battery cells and the temperature level is greater than the maximum temperature level in the technical specification and the battery pack 60 has degraded performance due to the temperature level, the supplier 30 would not have a duty to reimburse the OEM 33 for the cost of the replacement battery pack 61.

In a seventh example, for purposes of discussion, it is assumed that the OEM 33 has a duty under an OEM warranty contract 34 with the vehicle owner 35 to replace the vehicle battery pack 60. Further, a technical specification agreed upon between the OEM 33 and the supplier 30 indicates a maximum charging power level associated with the battery cells of the vehicle battery pack 60 above which could degrade or damage the vehicle battery pack 60. If the measured operational parameter is the charging power level of the battery cells and the charging power level is greater than the maximum charging power level in the technical specification and the battery pack has degraded performance due to the charging power level, the supplier 30 would not have a duty to reimburse the OEM 33 for the cost of the replacement battery pack 61.

In an eighth example, for purposes of discussion, it is assumed that the OEM 33 has a duty under an OEM warranty contract 34 with the vehicle owner 35 to replace the vehicle battery pack 60. Further, a technical specification agreed upon between the OEM 33 and the supplier 30 indicates a maximum discharging power level associated with the battery cells of the vehicle battery pack 60 above which could degrade or damage the vehicle battery pack 60. If the measured operational parameter is the discharging power level of the battery cells and the discharging power level is greater than the maximum discharging power level in the technical specification and the battery pack has degraded performance due to the discharging power level, the supplier 30 would not have a duty to reimburse the OEM 33 for the cost of the replacement battery pack 61.

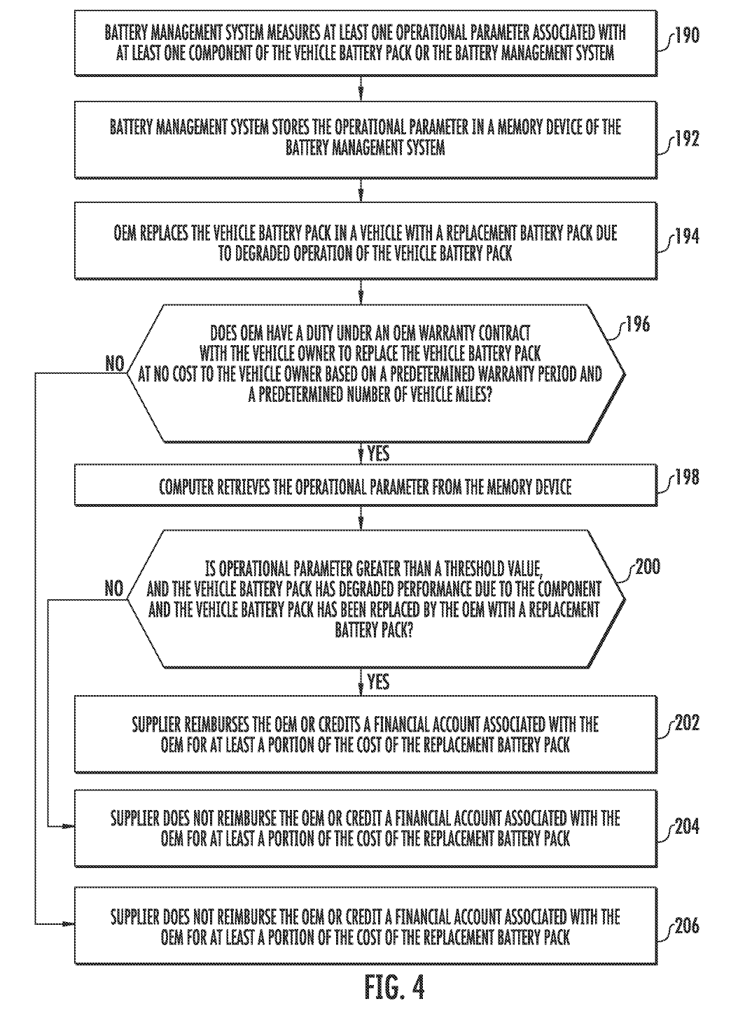

Referring to FIG. 4, a flowchart of another method for determining a warranty obligation utilizing an operational parameter in accordance with another exemplary embodiment will now be explained.

At step 190, the battery management system 40 measures at least one operational parameter associated with at least one component of the vehicle battery pack 60 or the battery management system 40.

At step 192, the battery management system 40 stores the operational parameter in the memory device 92 of the battery management system 40.

At step 194, the OEM 33 replaces the vehicle battery pack 60 in the vehicle 20 with a replacement battery pack 61 due to degraded operation of the vehicle battery pack 60.

At step 196, a determination is made as to whether the OEM 33 has a duty under an OEM warranty contract 34 with the vehicle owner 35 to replace the vehicle battery pack 60 at no cost to the vehicle owner 35 based on a predetermined warranty period and a predetermined number of vehicle miles. In one exemplary embodiment, the OEM 33 performs the step 156 and communicates the determination to the supplier 30. In another exemplary embodiment, the supplier 30 utilizes the supplier computer 24 to communicate with an external computer 26 to determine the whether the OEM 33 has a warranty obligation to the vehicle owner 35. If the value of step 196 equals “yes”, the method advances to step 198. Otherwise, the method advances to step 206.

At step 198, the computer 22 retrieves the operational parameter from the memory device 92.

At step 200, a determination is made as to whether the operational parameter is greater than a threshold value, and the vehicle battery pack 60 has degraded performance due to the component, and the vehicle battery pack 60 has been replaced by the OEM 33 with a replacement battery pack 61. The supplier 30 or the OEM 33 can make the determination at step 200. In one exemplary embodiment, the supplier computer 24 retrieves the operational parameter data from the microprocessor 90, and data from a technical specification database describing the technical specification that can be stored in the computer 24, and warranty data from the external computer 26 to make the determination at step 200. The computer 24 may further display the retrieved data, and/or the determination or results of step 200 on the display device 27. Further, in an alternative embodiment, the determination at step 200 may be manually performed by the supplier 30 or the OEM 33, or both. If the value of step 200 equals “yes”, the method advances to step 202. Otherwise, the method advances to step 204.

At step 202, the supplier 30 reimburses the OEM 33 or credits a financial account associated with the OEM 33 for at least a portion of the cost of the replacement battery pack 61.

Referring again to step 200, if the value of step 200 equals “no”, the method advances to step 204. At step 204, the supplier 30 does not reimburse the OEM 33 or credit a financial account associated with the OEM 33 for at least a portion of the cost of the replacement battery pack 61.

Referring again to step 196, if the value of step 196 equals “no”, the method advances to step 206. At step 206, the supplier 30 does not reimburse the OEM 33 or credit a financial account associated with the OEM 33 for at least a portion of the cost of the replacement battery pack 61.

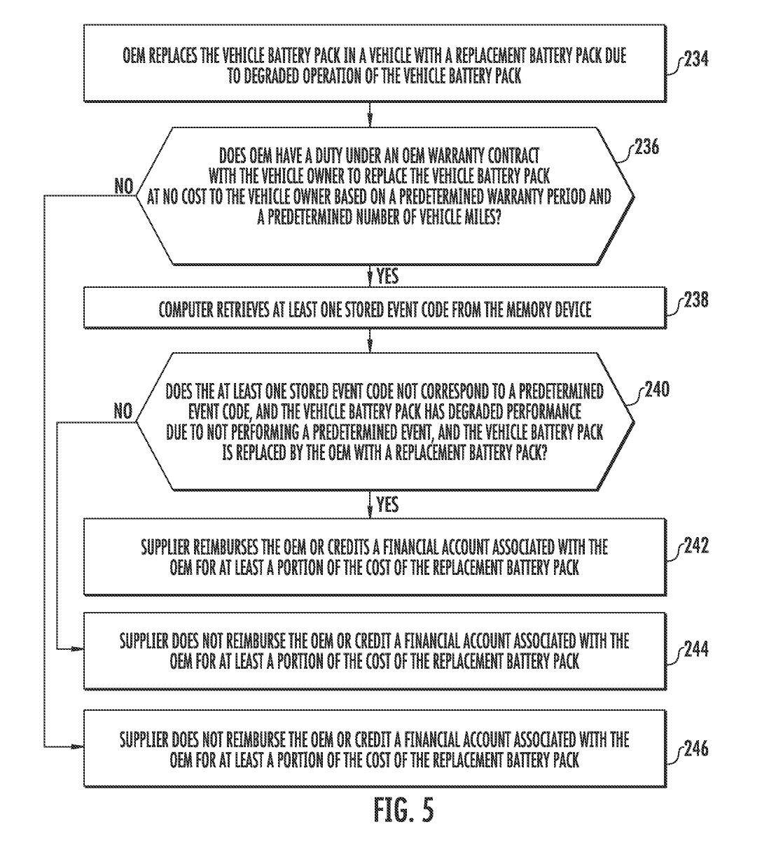

Referring to FIG. 5, a flowchart of another method for determining a warranty obligation based on an event in accordance with another exemplary embodiment will now be explained.

At step 234, the OEM 33 replaces the vehicle battery pack 60 in the vehicle 20 with a replacement battery pack 61 due to degraded operation of the vehicle battery pack 60.

At step 236, a determination is made as to whether the OEM 33 has a duty under an OEM warranty contract 34 with the vehicle owner 35 to replace the vehicle battery pack 60 at no cost to the vehicle owner 35 based on a predetermined warranty period and a predetermined number of vehicle miles. In one exemplary embodiment, the OEM 33 performs the step 236 and communicates the determination to the supplier 30. In another exemplary embodiment, the supplier 30 utilizes the supplier computer 24 to communicate with an external computer 26 to determine the whether the OEM 33 has a warranty obligation to the vehicle owner 35. If the value of step 236 equals “yes”, the method advances to step 238. Otherwise, the method advances to step 246.

At step 238, the computer 22 retrieves at least one stored event code from the memory device 92 and displays the at least one stored event code on the display device 23.

At step 240, a determination is made as to whether the at least one stored event code does not correspond to a predetermined event code, and the vehicle battery pack 60 has degraded performance due to not performing a predetermined event associated with the predetermined event code, and the vehicle battery pack 60 is replaced by the OEM 33 with a replacement battery pack 61. The supplier 30 or the OEM 33, or both can make the determination at step 240. In one exemplary embodiment, the supplier computer 24 retrieves the event codes from the microprocessor 90, and data from a technical specification database describing the technical specification 31 that can be stored in the computer 24, and warranty data from the external computer 26 to make the determination at step 240. The computer 24 may further display the retrieved data, and/or the determination or results of step 240 on the display device 27. Further, in an alternative embodiment, the determination at step 240 may be manually performed by the supplier 30 or the OEM 33, or both. If the value of step 240 equals “yes”, the method advances to step 242. Otherwise, the method advances to step 244.

At step 242, the supplier 30 reimburses the OEM 33 or credits a financial account associated with the OEM 33 for at least a portion of the cost of the replacement battery pack 61.

Referring again to step 240, if the value of step 240 equals “no”, the method advances to step 244. At step 244, the supplier 30 does not reimburse the OEM 33 or credit a financial account associated with the OEM 33 for at least a portion of the cost of the replacement battery pack 61.

Referring again to step 236, if the value of step 236 equals “no”, the method advances to step 240. At step 240, the supplier 30 does not reimburse the OEM 33 or credit a financial account associated with the OEM 33 for at least a portion the cost of the replacement battery pack 61.

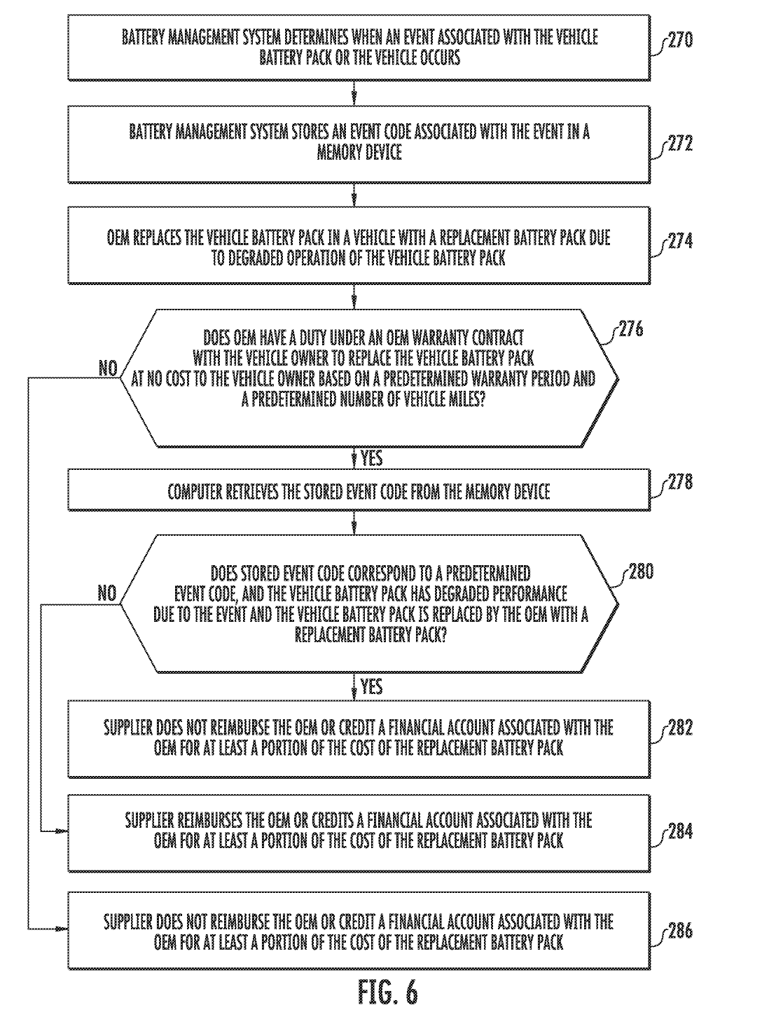

Referring to FIG. 6, a flowchart of another method for determining a warranty obligation based on an event in accordance with another exemplary embodiment will now be explained.

At step 270, the battery management system 40 determines when an event associated with the vehicle battery pack 60 occurs or when an event associated with the vehicle 20 such as a vehicle collision event occurs. The system 40 can determine that the event has occurred based on signals received by the microprocessor 90 or from external event codes received from the vehicle controller 42.

At step 272, the battery management system 40 stores an event code associated with the event in the memory device 92.

At step 274, the OEM 33 replaces the vehicle battery pack 60 in the vehicle 20 with a replacement battery pack 61 due to degraded operation of the vehicle battery pack 60.

At step 276, a determination is made as to whether the OEM 33 has a duty under an OEM warranty contract 34 with the vehicle owner 35 to replace the vehicle battery pack 60 at no cost to the vehicle owner 35 based on a predetermined warranty period and a predetermined number of vehicle miles. In one exemplary embodiment, the OEM 33 performs the step 276 and communicates the determination to the supplier 30. In another exemplary embodiment, the supplier 30 utilizes the supplier computer 24 to communicate with an external computer 26 to determine the whether the OEM 33 has a warranty obligation to the vehicle owner 35. If the value of step 276 equals “yes”, the method advances to step 278. Otherwise, the method advances to step 286.

At step 278, the computer 22 retrieves the stored event code from the memory device 92 and displays the event code on the display device 23.

At step 280, a determination is made as to whether the stored event code corresponds to a predetermined event code, and the vehicle battery pack 60 has degraded performance due to the event, and the vehicle battery pack 60 is replaced by the OEM 33 with a replacement battery pack 61. The supplier 30 or the OEM 33, or both can make the determination at step 280. In one exemplary embodiment, the supplier computer 24 retrieves the event codes from the microprocessor 90, and data from a technical specification database describing the technical specification 31 that can be stored in the computer 24, and warranty data from the external computer 26 to make the determination at step 280. The computer 24 may further display the retrieved data, and/or the determination or results of step 280 on the display device 27. Further, in an alternative embodiment, the determination at step 280 may be manually performed by the supplier 30 or the OEM 33, or both. If the value of step 280 equals “yes”, the method advances to step 282. Otherwise, the method advances to step 284.

At step 282, the supplier 30 does not reimburse the OEM 33 or credit a financial account associated with the OEM 33 for at least a portion of the cost of the replacement battery pack 61.

Referring again to step 280, if the value of step 280 equals “no”, the method advances to step 284. At step 284, the supplier 30 reimburses the OEM 33 or credits a financial account associated with the OEM 33 for at least a portion of the cost of the replacement battery pack 61.

Referring again to step 276, if the value of step 276 equals “no”, the method advances to step 286. At step 286, the supplier 30 does not reimburse the OEM 33 or credit a financial account associated with the OEM 33 for at least a portion the cost of the replacement battery pack 61.

A practical example of how the method described in FIG. 6 could be implemented will now be explained. For purposes of discussion, it is assumed that the OEM 33 has a duty under an OEM warranty contract 34 with the vehicle owner 35 to replace the vehicle battery pack 60. Further, the warranty contract between the OEM 33 and the supplier 30 indicates that the supplier 30 will not have any obligation to replace the vehicle battery pack 60 in the event of a vehicle collision event or vehicle impact event. If the event code retrieved from the non-volatile memory 92 indicates that a vehicle collision event occurred, the supplier 30 would not have a duty to reimburse the OEM 33 for the cost of the replacement battery pack 61.

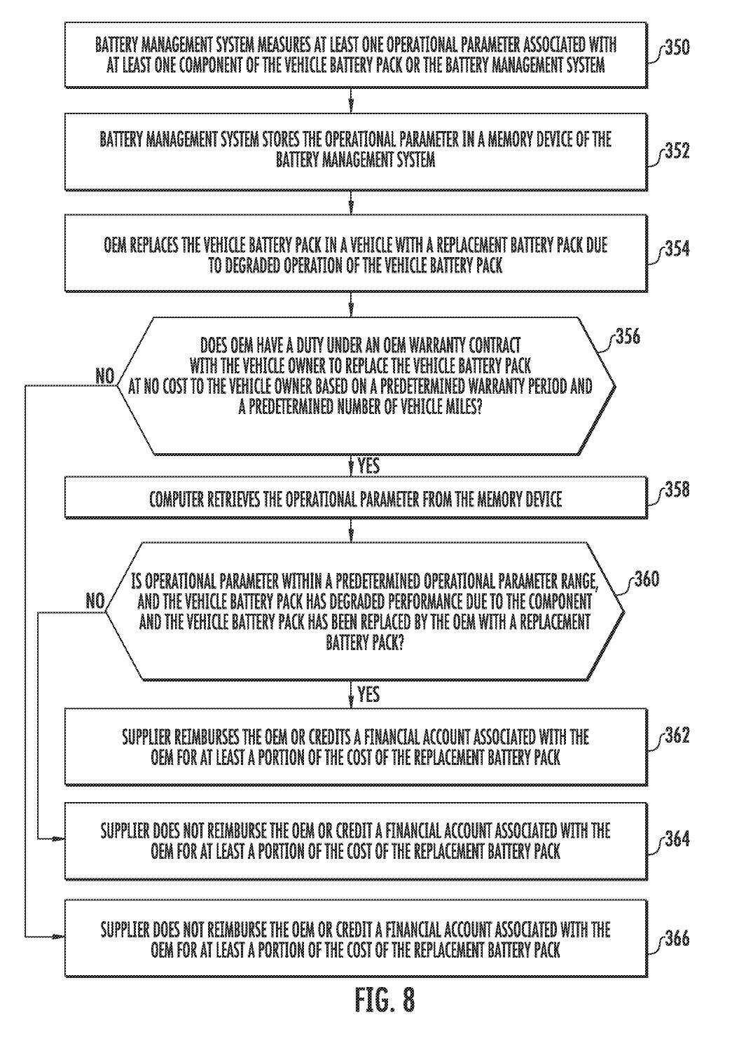

Referring to FIG. 8, a flowchart of a method for determining a warranty obligation utilizing an operational parameter in accordance with another exemplary embodiment will now be explained.

At step 350, the battery management system 40 measures at least one operational parameter associated with at least one component of the vehicle battery pack 60 or the battery management system 40.

At step 352, the battery management system 40 stores the operational parameter in the memory device 92 of the battery management system 40.

At step 354, the OEM 33 replaces the vehicle battery pack 60 in the vehicle 20 with the replacement battery pack 61 due to degraded operation of the vehicle battery pack 60.

At step 356, a determination is made as to whether the OEM has a duty under an OEM warranty contract 34 with the vehicle owner 35 to replace the vehicle battery pack 60 at no cost to the vehicle owner 35 based on a predetermined warranty period and a predetermined number of vehicle miles. In one exemplary embodiment, the OEM 33 performs the step 356 and communicates the determination to the supplier 30. In another exemplary embodiment, the supplier 30 utilizes the supplier computer 24 to communicate with the external computer 26 to determine whether the OEM 33 has a warranty obligation to the vehicle owner 35. If the value of step 356 equals “yes”, the method advances to step 358. Otherwise, the method advances to step 366.

At step 358, the computer 22 retrieves the operational parameter from the memory device 92.

At step 360, a determination is made as to whether the operational parameter is within a predetermined operational parameter range, and the vehicle battery pack 60 has degraded performance due to the component, and the vehicle battery pack 60 has been replaced by the OEM 33 with the replacement battery pack 61. The supplier 30 or the OEM 33, or both can make the determination at step 360. In one exemplary embodiment, the supplier computer 24 retrieves the operational parameter data from the microprocessor 90, and data from a technical specification database describing the technical specification that can be stored in the computer 24, and warranty data from the external computer 26 to make the determination at step 360. The computer 24 may further display the retrieved data, and/or the determination or results of step 360 on the display device 27. Further, in an alternative embodiment, the determination at step 360 may be manually performed by the supplier 30 or the OEM 33, or both. If the value of step 360 equals “yes”, the method advances to step 362. Otherwise, the method advances to step 364. In one exemplary embodiment, the component is at least one battery cell in the vehicle battery pack 60, and the operational parameter is a state-of-charge of the at least one battery cell in the vehicle battery pack 60, and the predetermined operational parameter range is a predetermined state-of-charge range. The predetermined state-of-charge range has an upper threshold value and a lower threshold value which is less than the upper threshold value.

At step 362, the supplier 30 reimburses the OEM 33 or credits a financial account associated with the OEM 33 for at least a portion of the cost of the replacement battery pack 61.

Referring again to step 360, if the value of step 360 equals “no”, the method advances to step 364. At step 364, the supplier 30 does not reimburse the OEM 33 or credit a financial account associated with the OEM 33 for at least a portion of the cost of the replacement battery pack 61.

Referring again to step 356, if the value of step 356 equals “no’, the method advances to step 366. At step 366, the supplier 30 does not reimburse the OEM 33 or credit a financial account associated with the OEM 33 for at least a portion of the cost of the replacement battery pack 61.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

We claim:

1. A method for determining a warranty obligation of a supplier to an OEM relating to a vehicle battery pack of a vehicle, the vehicle battery pack being previously purchased by the OEM from the supplier, the method comprising:
retrieving a stored operational parameter associated with at least one component of the vehicle battery pack or a battery management system from a memory device of the battery management system, utilizing a computer;
determining whether the operational parameter is less than or equal to a threshold value, if the vehicle battery pack has degraded performance due to the component and the vehicle battery pack is replaced by the OEM with a replacement battery pack; and
reimbursing the OEM or crediting a financial account associated with the OEM for at least a portion of the cost of the replacement battery pack by the supplier if the operational parameter is less than or equal to the threshold value and the vehicle battery pack has degraded performance due to the component and the vehicle battery pack is replaced by the OEM with the replacement battery pack.

2. The method of claim 1, further comprising:
measuring the operational parameter associated with the at least one component of the vehicle battery pack or the battery management system, utilizing the battery management system; and
storing the operational parameter in the memory device of the battery management system.

3. The method of claim 1, wherein the component is a power contactor electrically coupled to the vehicle battery pack and the operational parameter is a threshold number of open-close cycles of the power contactor at full-load over a predetermined time interval, the threshold number of open-close cycles being identified in a technical specification associated with the battery management system.

4. The method of claim 1, wherein the operational parameter comprises a number of open-close cycles of the power contactor at full-load over a predetermined time interval.

5. The method of claim 1, further comprising not reimbursing the OEM for the cost of the replacement battery pack if the operational parameter is greater than the threshold value.

6. The method of claim 1, wherein the at least the portion of the cost of the replacement battery pack includes a purchase price of the replacement battery pack, labor costs associated with installing the replacement battery pack in the vehicle, and shipping costs of the replacement battery pack.

7. The method of claim 1, further comprising determining whether the OEM has a duty under an OEM warranty contract with a vehicle owner to replace the vehicle battery pack based on a predetermined warranty period and a predetermined number of vehicle miles.

8. A method for determining a warranty obligation of a supplier to an OEM relating to a vehicle battery pack of a vehicle, the vehicle battery pack being previously purchased by the OEM from the supplier, the method comprising:
retrieving a stored operational parameter associated with at least one component of the vehicle battery pack or a battery management system from a memory device of the battery management system, utilizing a computer;
determining whether the operational parameter is greater than a threshold value, if the vehicle battery pack has degraded performance due to the component and the vehicle battery pack is replaced by the OEM with a replacement battery pack; and
reimbursing the OEM or crediting a financial account associated with the OEM for at least a portion of the cost of the replacement battery pack by the supplier if the operational parameter is greater than the threshold value and the vehicle battery pack has degraded performance due to the component and the vehicle battery pack is replaced by the OEM with the replacement battery pack.

9. The method of claim 8, further comprising:
measuring the operational parameter associated with the component of the vehicle battery pack, utilizing the battery management system;
storing the operational parameter in the memory device of the battery management system.

10. The method of claim 8, wherein the operational parameter comprises at least one of a battery cell temperature level, a battery cell voltage level, a battery pack current level, and a battery pack energy throughput amount.

11. The method of claim 8, further comprising not reimbursing the OEM for the cost of the replacement battery pack if the operational parameter is less than or equal to the threshold value.

12. A method for determining a warranty obligation of a supplier to an OEM relating to a vehicle battery pack of a vehicle, the vehicle battery pack being previously purchased by the OEM from the supplier, the method comprising:
retrieving a stored event code associated with an event that has occurred in the vehicle battery pack or has occurred in the vehicle from a memory device of a battery management system, utilizing a computer;
determining whether the stored event code corresponds to a predetermined event code, if the vehicle battery pack has degraded performance due to the event and the vehicle battery pack is replaced by the OEM with a replacement battery pack; and reimbursing the OEM or crediting a financial account associated with the OEM for at least a portion of the cost of the replacement battery pack by the supplier if the stored event code corresponds to the predetermined event code and the vehicle battery pack has degraded performance due to the event associated with the event code and the vehicle battery pack is replaced by the OEM with the replacement battery pack.

13. The method of claim 12, further comprising:
determining when the event associated with the vehicle battery pack or the vehicle has occurred, utilizing the battery management system; and
storing the event code associated with the event in the memory device of the battery management system.

14. A method for determining a warranty obligation of a supplier to an OEM relating to a vehicle battery pack of a vehicle, the vehicle battery pack being previously purchased by the OEM from the supplier, the method comprising:
retrieving a stored event code associated with an event that has occurred in the vehicle battery pack or has occurred in the vehicle from a memory device of a battery management system, utilizing a computer;
determining whether the stored event code corresponds to a predetermined event code, if the vehicle battery pack has degraded performance due to the event and the vehicle battery pack is replaced by the OEM with a replacement battery pack; and
not reimbursing the OEM or crediting a financial account associated with the OEM for at least a portion of the cost of the replacement battery pack by the supplier if the stored event code corresponds to the predetermined event code and the vehicle battery pack has degraded performance due to the event associated with the event code and the vehicle battery pack is replaced by the OEM with the replacement battery pack.

15. A method for determining a warranty obligation of a supplier to an OEM relating to a vehicle battery pack of a vehicle, the vehicle battery pack being previously purchased by the OEM from the supplier, the method comprising:
retrieving a stored operational parameter associated with at least one component of the vehicle battery pack or a battery management system from a memory device of the battery management system, utilizing a computer;
determining whether the operational parameter is within a predetermined operational parameter range, if the vehicle battery pack has degraded performance due to the component and the vehicle battery pack is replaced by the OEM with a replacement battery pack, the predetermined operational parameter range having an upper threshold value and a lower threshold value; and
reimbursing the OEM or crediting a financial account associated with the OEM for at least a portion of the cost of the replacement battery pack by the supplier if the operational parameter is within the predetermined operational parameter range and the vehicle battery pack has degraded performance due to the component and the vehicle battery pack is replaced by the OEM with the replacement battery pack.

16. The method of claim 15, further comprising not reimbursing the OEM or crediting a financial account associated with the OEM for at least a portion of the cost of the replacement battery pack by the supplier if the operational parameter is not within the predetermined operational parameter range and the vehicle battery pack has degraded performance due to the component and the vehicle battery pack is replaced by the OEM with the replacement battery pack.

17. The method of claim 15, wherein the component is at least one battery cell in the vehicle battery pack, the operational parameter is a state-of-charge of the at least one battery cell in the vehicle battery pack, and the predetermined operational parameter range is a predetermined state-of-charge range.
